(19) United States
(12) Patent Application Publication
(10) Pub. No.: US 2012/0239677 A1
(43) Pub. Date: Sep. 20, 2012

(54) COLLABORATIVE KNOWLEDGE MANAGEMENT

(75) Inventor: David Neale, Summer Hill (AU)

(73) Assignee: Moxy Studios Pty Ltd.

(21) Appl. No.: 13/048,086

(22) Filed: Mar. 15, 2011

(30) Foreign Application Priority Data
Mar. 14, 2011 (AU) 2011201127

(51) Int. Cl. G06F 17/30

(52) U.S. Cl. 707/759; 707/769; 707/E17.014

(57) ABSTRACT

A computer-implemented method for collaborative knowledge management, the method comprises the steps of: (a) providing an interface for users to create or edit pages of a collaborative knowledge base, to add semantic annotations to the pages, and to define dynamic data on the pages; wherein ontological statements are created for the semantic annotations to form part of an ontology; and the dynamic data is defined using a query against the ontology and a mathematical operation on a result of the query; and (h) when a page with dynamic data is accessed, dynamically performing the query and the mathematical operation, and presenting the page with a result of the query or a result of the mathematical operation, or both, in graphical form.

### TECHNICAL FIELD

This disclosure generally concerns knowledge management. More particularly, this disclosure concerns a computer-implemented method for collaborative knowledge management, and a computer system and a computer program for implementing the method.

### BACKGROUND

The Internet has presented an opportunity to anyone with online access to become a potential content publisher. A well-known online collaborative environment for content publishing is Wikipedia (trade mark of Wikipedia, Inc), which was developed based on the principles designed by Ward Cunningham in 1994. Wikipedia is powered by Mediawiki, an open source software that retains a history of all edits and changes. Users can author a new or edit an existing Wikipedia entry that generally contains a description and accompanying images.

### SUMMARY

According to a first aspect, there is provided a computer-implemented method for collaborative knowledge management, the method comprises the steps of:
(a) providing an interface for users to create or edit pages of a collaborative knowledge base, to add semantic annotations to the pages, and to define dynamic data on the pages;
wherein ontological statements are created for the semantic annotations to form part of an ontology; and the dynamic data is defined using a query against the ontology and a mathematical operation on a result of the query; and
(b) when a page with dynamic data is accessed, dynamically performing the query and the mathematical operation, and presenting the page with a result of the query or a result of the mathematical operation, or both, in graphical form.

Performing the mathematical operation may further comprise converting the query, or the result of the query, into a form that can be evaluated by a mathematical engine.

The mathematical engine may be implemented using any one of the following programming languages: R, Matlab, Octave, PHP and Python.

The method may further comprise semantically annotating the page accessed with the result of the mathematical operation.

The ontological statements Resource Data Framework (RDF) statements each may comprise a triple of (subject, predicate, object). In this case, the query may be a SPARQL query against the ontology.

Semantic annotations of a page may include one or more categories and properties that, for example, are related to the content of the page. In this case, the method may further comprise providing an interface for the users to select the one or more categories and properties during semantic annotation.

The method may further comprise providing an interface for the users to select the mathematical operation, and automatically generating a script to perform the selected mathematical operation.

The method may further comprise providing an interface for the users to select the graphical form. The graphical form may be a plot generated using the result of the query or the result of the mathematical operation, or both. The graphical form may also be a map indicating the result of the query or the result of the mathematical operation, or both.

The knowledge base may be implemented using Semantic Wiki.

According to a second aspect, there is provided a computer program to implement the method according to the first aspect. The computer program may be embodied in a computer-readable medium such that when code of the computer program is executed, causes a computer system to implement the method.

According to a third aspect, there is provided a computer system for collaborative knowledge management, the computer system comprising:
a data store to store a knowledge base comprising pages created and editable by multiple users and an ontology comprising ontological statements; and
a processing unit operable to:
   (a) provide an interface for users to create or edit pages of the collaborative knowledge base, to add semantic annotations to the pages, and to define dynamic data on the pages;
   wherein ontological statements for the semantic annotations form part of the ontology in the data store; and the dynamic data is defined using a query against the ontology and a mathematical operation on a result of the query; and
(b) when a page with dynamic data is accessed, dynamically perform the query and the mathematical operation, and present the page with a result of the query or a result of the mathematical operation, or both, in graphical form.

### BRIEF DESCRIPTION OF DRAWINGS

Non-limiting example(s) of the computer-implemented method and computer system will now be described with reference to the accompanying drawings, in which:

FIG. 1 is a schematic diagram of an exemplary computer system for collaborative knowledge management.

FIG. 2 is a flowchart of an exemplary method performed by the processing unit in FIG. 1 for collaborative knowledge management.

FIG. 3 is a screenshot of an interface for creating or editing a page entitled “West Antarctic Ice Sheet”.

FIG. 4 is a screenshot of an interface for semantically annotating the “West Antarctic Ice Sheet” page in FIG. 3.

FIG. 5 is a graph of ontological statements that form part of an ontology.

FIG. 6 is a screenshot of an interface for creating or editing a page with dynamic data entitled “Global Grounded Ice”.

FIG. 7 is a screenshot of an interface for defining the dynamic data on the “Global Grounded Ice” page in FIG. 6.

FIG. 8(a) is a screenshot of a page entitled “What if all the ice melts” that uses a Volume property of the “Global Grounded Ice” page in FIG. 6.

FIG. 8(b) is a screenshot showing a result of mathematical operation using the Volume property.

FIG. 9 is a screenshot of an exemplary ontology browser.

### DETAILED DESCRIPTION

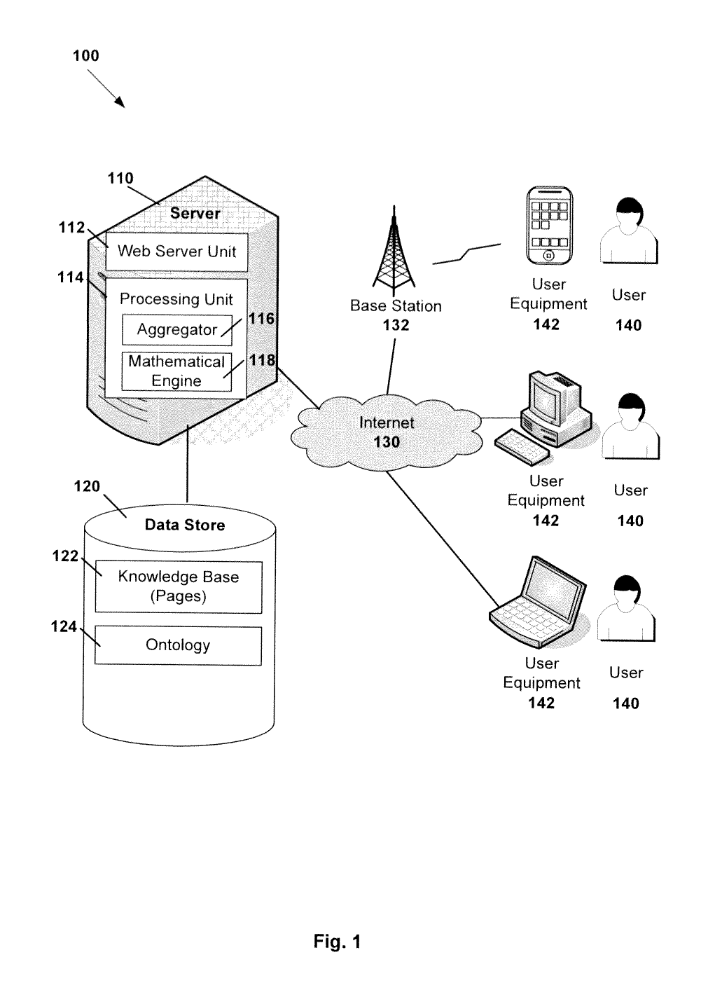

Referring first to FIG. 1, the exemplary computer system 100 for collaborative knowledge management comprises a server 110 and a data store 120. The server 110 includes a web server unit 112 that configures the server 110 to operate as a web server, and a processing unit 114 that controls the operation of the server. Both the web server unit 112 and processing unit 114 include computer program code to perform their respective functions. The data store 120 may be a local data store, or in the case of cloud computing, connected to the server 110 remotely.

In one application, the computer system 100 is used for collaborative modelling. The data store 120 stores a knowledge base comprises Wiki-type pages 122 that are created and editable by users 140 to share facts, models and analysis. Advantageously, the computer system 100 provides a complete traceability into where facts and numbers used in an analysis come from, and allows users to build evidence-based models of real world problems in an open, collaborative and decentralised manner. Users 140 can capture facts from unstructured sources, model those facts in support of a position or recommendation and share that analysis with other users 140.

The users 140 connect to the server 110 via a wide area communications network 130 such as the Internet, and in the case of mobile communications, a wireless communications network comprising a base station or access point 132. Each user 140 operates a user equipment 142 that is capable of receiving input data from a data entry device such as keyboard, stylus and touch screen as well as displaying output data using a display screen. Examples of suitable user equipment include mobile phone, smart phone, personal digital assistant (PDA), laptop, desktop and tablet.

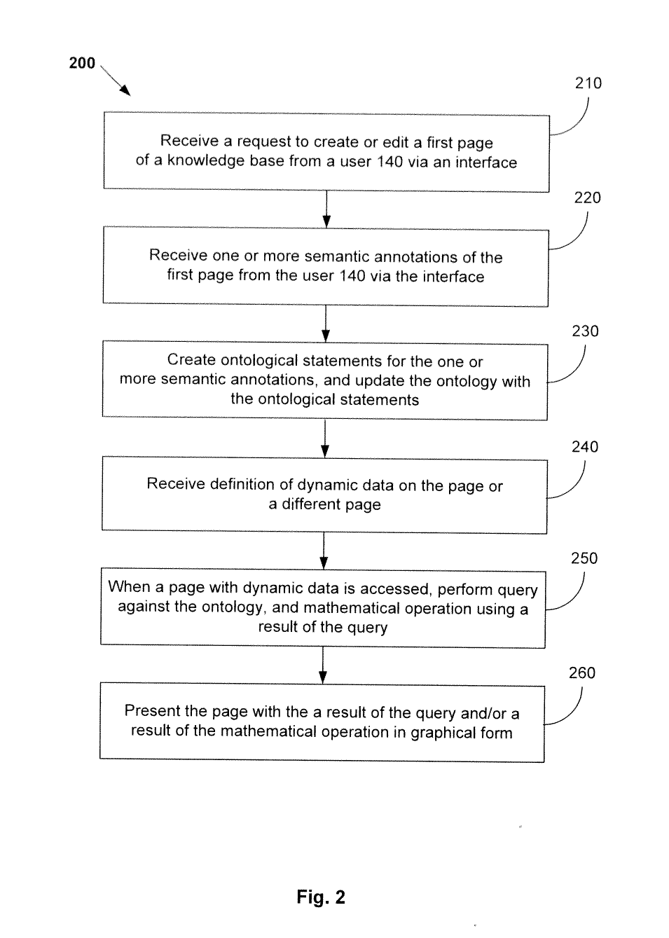

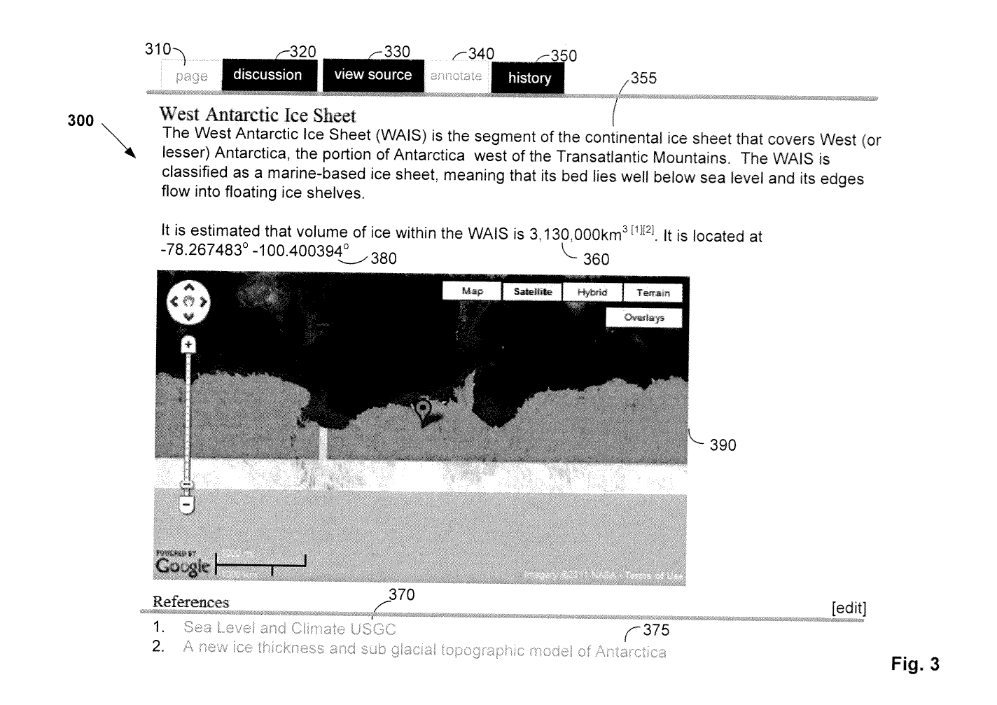

An example of how the computer system 100 is implemented will now be discussed with reference to the flowchart in FIG. 2 and examples in FIGS. 3 to 9.

### Page Creation or Editing

The web server unit 112 first receives a user's 140 request to create a new page or edit a page in the knowledge base 122; see step 210 in FIG. 2.

The user 140 submits content for the page to the web server unit 112 using the interface shown in FIG. 3. The interface 300 may be powered by suitable software such as Semantic MediaWiki (SMW), which stores the pages 122 in multiple tables designed for fast querying within the data store 120. Compared with traditional Wikipedia, SMW allows semantic annotations of a page.

More specifically, the page 300 in FIG. 3 is created to describe the West Antarctic Ice Sheet. Multiple page tabs are provided on the interface to allow the user 140 to perform various actions, such as:
viewing the page by clicking on the “page” tab 310;
joining other users for a discussion by clicking on the “discussion” tab 320;
editing the page by clicking the on “view source” tab 330;
editing semantic annotations by clicking on the “annotate” tab 340; and
viewing the history of the page by clicking on the “history” tab 350.

Once the page or changes to the page are saved using the “Save Changes” button, the page will be saved in the data store 120, such as in the form of a MediaWiki Script. If a user 140 is not logged in when creating or editing a page 122, the IP address of the user 140 will be recorded publicly in the page's edit history. A user 140 who is logged in, however, is able to conceal their IP address.

### Semantic Annotations

Once a page is semantically annotated and submitted by the user 140, the semantic annotations of the page created or edited in step 210 are received by the web server unit 112; see step 220 in FIG. 2. Semantically annotating the pages facilitates semantic search, which can be contrasted with conventional keyword-based searching.

Referring again to FIG. 3, the page 300 describes the West Antarctic Ice Sheet as a “continental ice sheet” 355. Its volume 360 is “3,130,000 km3” as supported by references “Sea Level and Climate USGC” 370 and “A new ice thickness and subglacial topographic model of Antarctica” 375. The geolocation 380 of the West Antarctic Ice Sheet is also defined.

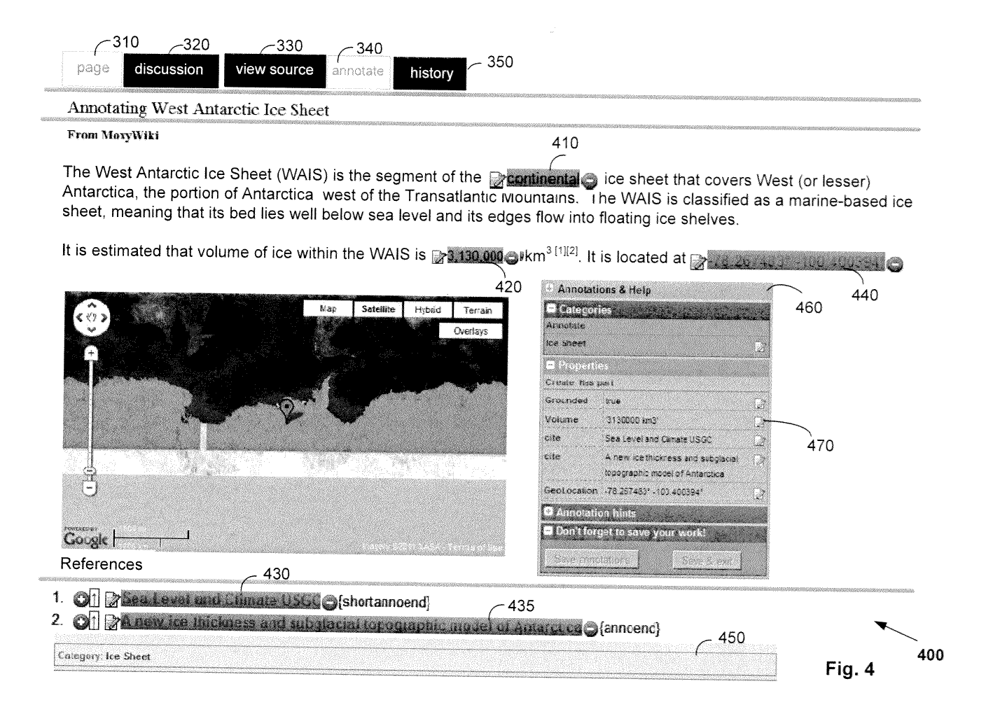

Referring also to FIG. 4, the user 140 can add one or more semantic annotations to the page using the “annotate” tab or interface 340. In this example, the page is semantically annotated with the following properties:
Grounded property 410, which has Boolean value of true or false indicating whether the ice sheet is grounded;
Volume property 420, which is the volume of the ice sheet;
Cite property 430 and 435, which defines a reference cited on the page; and
GeoLocation property 440, which is the geographic coordinate of the ice sheet described on the page.

The page is also semantically annotated with category “Ice Sheet” 450. An “Annotations & Help” sub-interface 460 allows the user 140 to view and edit the semantic annotations. For example, the value of the “Volume” property 420 can be edited by clicking on the “edit” icon 470.

Alternatively or additionally, the user 40 can add or edit semantic annotations using the “view source” tab 330. The corresponding MediaWiki script for the page in FIG. 3 and FIG. 4 is as follows:

| | |
|---|---|
| 1 | The West Antarctic Ice Sheet (WAIS) is the segment of the |
| 2 | [[Grounded::true\|continental]] ice sheet that covers West |
| 3 | (or Lesser) Antarctica, the portion of Antarctica west of |
| 4 | the Transantarctic Mountains. The WAIS is classified as a |
| 5 | marine-based ice sheet, meaning that its bed lies well |
| 6 | below sea level and its edges flow into floating ice |
| 7 | shelves. |
| 8 | |
| 9 | It is estimaged that volume of ice within the WAIS is |
| 10 | [[Volume::‘3130000 km3’\|3,130,000]]km<sup>3</sup>. |
| 11 | <ref>[[cite::Sea Level and Climate USGC]]</ref> |
| 12 | <ref>[[cite::A new ice thickness and subglacial |
| 13 | topographic model of Antarctica]]</ref> |
| 14 | It is located at [[GeoLocation::−78.267483° −100.400394°]] |
| 15 | [[Category:Ice Sheet]] |

Using the reference numerals in FIG. 4, the Grounded property 410 is defined in line 2. Similarly, the Volume property 420 is defined in line 10, and the GeoLocation property 440 in line 14. References cited are defined using the Cite property 430 and 435 in lines 11 to 13. Line 15 defines the Category 450 as “Ice Sheet”.

Although the semantic annotations have been exemplified using properties and categories, it will be appreciated that they are not limited to such examples. Other types of semantic annotations may be used, such as rules defined using if-then (antecedent-consequent) statement; axioms; events; restrictions; and parameters that an object has.

### Ontological Statements

Once a page is semantically annotated, the processing unit 114 creates an ontological statement for each semantic annotation received from the user 140; see step 230 in FIG. 2. The ontological statements form part of the ontology 124 in the data store 120; see step 240.

In the field of computer science, ontology is a formal representation of information as a set of entities within a domain and relationships between those entities. In general, ontology is schema-less, meaning that it is not tied to a specific schema and is therefore flexible enough to model any information. As the ontology 124 is extended with ontological statements over time, a shared and reusable vocabulary for discussions and information organisation can be built for the purpose of collaborative knowledge management.

An ontology language is a formal language used to encode the ontology 124. In one exemplary implementation, the ontological statements are created as Resource Data Framework (RDF) statements in step 230 in FIG. 2. RDF is developed by the World Wide Web Consortium (W3C) for web-based metadata to, inter alia, make management and navigation of Web data easier and facilitate interoperability between applications that exchange information on the Web.

An RDF statement comprises the triples:
(subject, predicate and object),
   where:
subject is a specific resource such as a page in the knowledge base 122,
predicate denotes a relationship between the subject and the object and is also known as the property. It may be a specific resource such as a page in the knowledge base 122; and
object is the value of the property.

The subject and object may be a Uniform Resource Identifier (URI) with optional fragment identifier (URI reference), a literal or a blank node. A set of RDF statements is known as an RDF graph, which can be traversed using well-tested graph traversal techniques when the ontology 124 is queried.

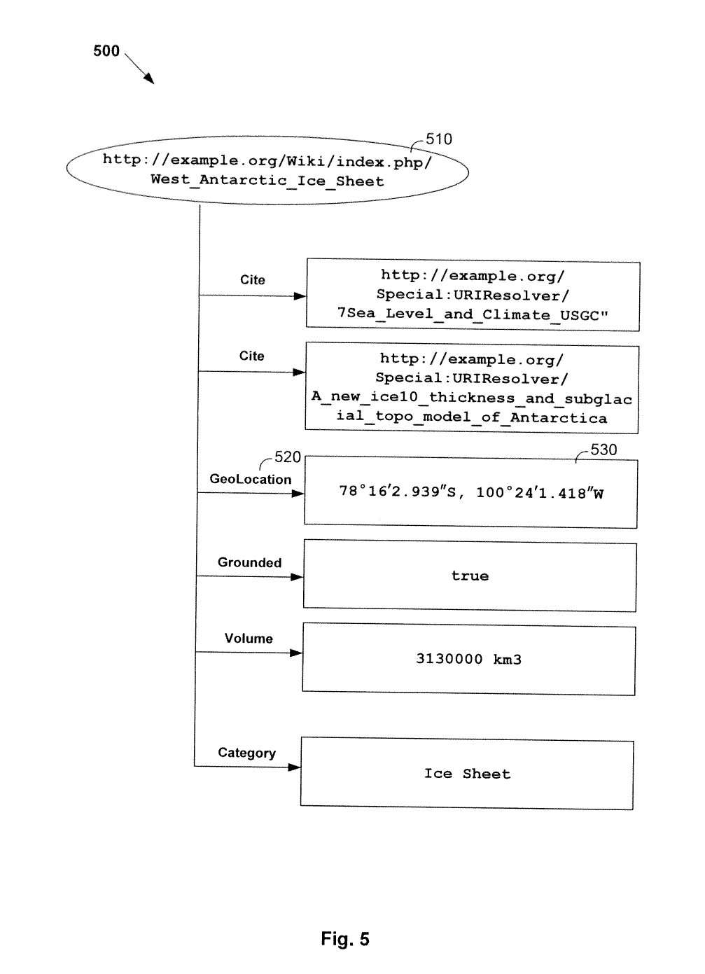

The RDF statements created for the “West Antarctic Ice Sheet” page in FIG. 3 and FIG. 4 are represented in FIG. 5 using a directed labelled graph 500. The direction of the arrows is important. The arc always starts at the subject (resource) and points to the object (value). For example, the RDF statement for the GeoLocation property of the “West Antarctic Ice Sheet” page is:
(http://example.org/Wiki/index.php/West_Antarctic_Ice_Sheet, GeoLocation, 78°16′2.939″S, 100°24′1.418″W)
   where:
subject is a web address 510 to the page,
predicate is GeoLocation 520, and
object is the value of the GeoLocation property, i.e. 78°16′2.939″S, 100′24′1.418″W 530.

The corresponding RDF statements for the semantic annotations for the “West Antarctic Ice Sheet” page are as follows:

RDF Statements

| | |
|---|---|
| 1 | <swivt:Subject |
| 2 | <rdf:type |
| 3 | rdf:resource=“http://example.org/Special:URIResolver/ |
| 4 | Category-3AIce_Sheet” /> |
| 5 | <property:Cite |
| 6 | rdf:resource=“http://example.org/Special:URIResolver/ |
| 7 | Sea_Level_and_Climate_USGC” /> |
| 8 | <property:Cite |
| 9 | rdf:resource=“http://example.org/Special:URIResolver/ |
| 10 | A_new_ice _thickness_and_subglacial_topo_model_of_{—} |
| 11 | Antarctica”/> |
| 12 | <property:GeoLocation |
| 13 | rdf:datatype=“http://www.w3.org/2001/XMLSchema# |
| 14 | string”>78°16′2.939″S, 100°24′1.418″W |
| 15 | </property:GeoLocation> |
| 16 | <property:Grounded |
| 17 | rdf:datatype=“http://www.w3.org/2001/XMLSchema# |
| 18 | boolean”>true |
| 19 | </property:Grounded> |
| 20 | <property:Volume |
| 21 | rdf:datatype=“http://www.w3.org/2001/XMLSchema# |
| 22 | string”>‘3130000 km3’ |
| 23 | </property:Volume> |
| 24 | </swivt:Subject> |

The Semantic Wiki Vocabulary and Terminology (SWIVT) in lines 1 and 24 is used for interpreting the semantic content exported by SMW. The SWIVT ontology is based on the W3C format Web Ontology Language (OWL) and its specification is accessible via http://semantic-mediawiki.org/swivt/, the content of which is incorporated herein by reference.

rdf:type is an instance of rd:Property used to state that a resource is an instance of a class, rdf:resource defines the class resource, and rdf:datatype defines the datatype of a property such string and Boolean. Lines 5 to 11 export two references defined using the Cite property. Lines 12 to 15 export the GeoLocation property, lines 16 to 19 the Grounded property and lines 20 to 23 the Volume property.

### Dynamic Data

Once pages are semantically annotated, a user 140 can also define dynamic data on a page; see step 240 in FIG. 2.

The term “dynamic data” is used broadly here to represent content of a page that is retrieved or evaluated in real time. The dynamic data can be defined using one or more of the following:
a query against the ontology 124 to retrieve data from one or more other pages;
a mathematical operation on a result of the query;
a graphical representation of a result of the query, or a result of the mathematical operation, or both; and
a table of a result of the query, or a result of the mathematical operation, or both.

The query is written in any suitable semantic web language such as SPARQL Protocol and RDF Query Language (SPARQL). The mathematical operation and gaphical representation can be implemented using any suitable programming language for data manipulation, calculation and graphical display, such as R, Matlab, Octave, PHP and Python.

Referring to the “West Antarctic Ice Sheet” page 300 in FIG. 3 again, the map 390 contains dynamic data that is retrieved in real time. Once the GeoLocation property 380 of the page 300 is stored as an ontological statement in the ontology 124, its value can be dynamically retrieved using a query against the ontology 124 as follows:

### Example 1

### Map

1 {{#ask:[[West Antarctic Ice Sheet]]
2 |?GeoLocation
3 |format=googlemaps
4 |showtitle=on
5 |zoom=1
6 |type = satellite}}

The ask query in line 1 tests whether or not the “West Antarctic Ice Sheet” exists, and if it does, retrieves its GeoLocation property in line 2. The GeoLocation property is then used in the Google map 390, whose characteristics are defined in lines 3 to 6. As such, if the Geo Location property is updated, the marker indicating the GeoLocation on the map 390 will also be updated automatically and in real time.

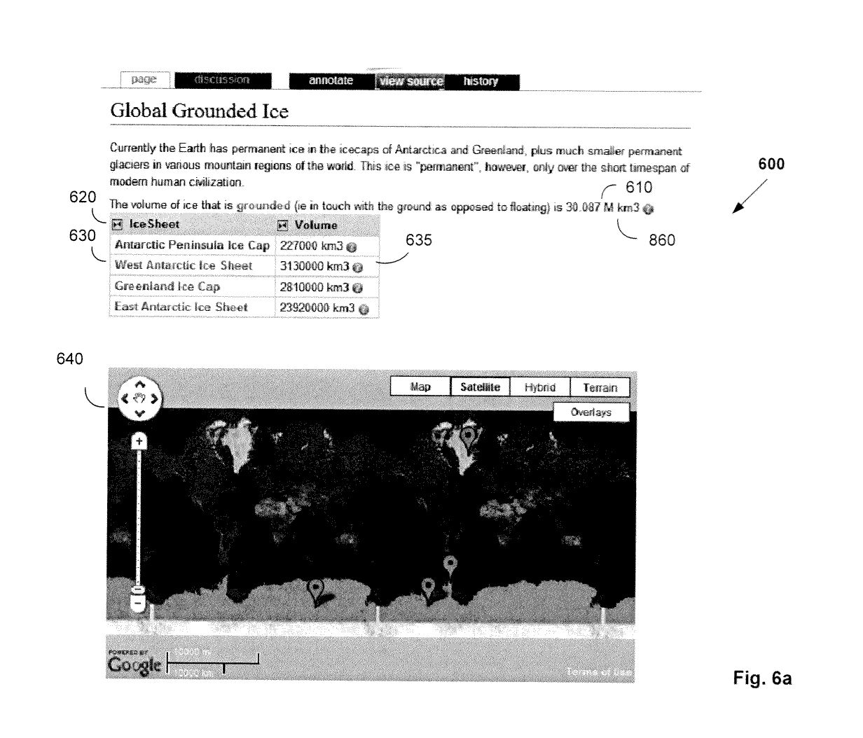

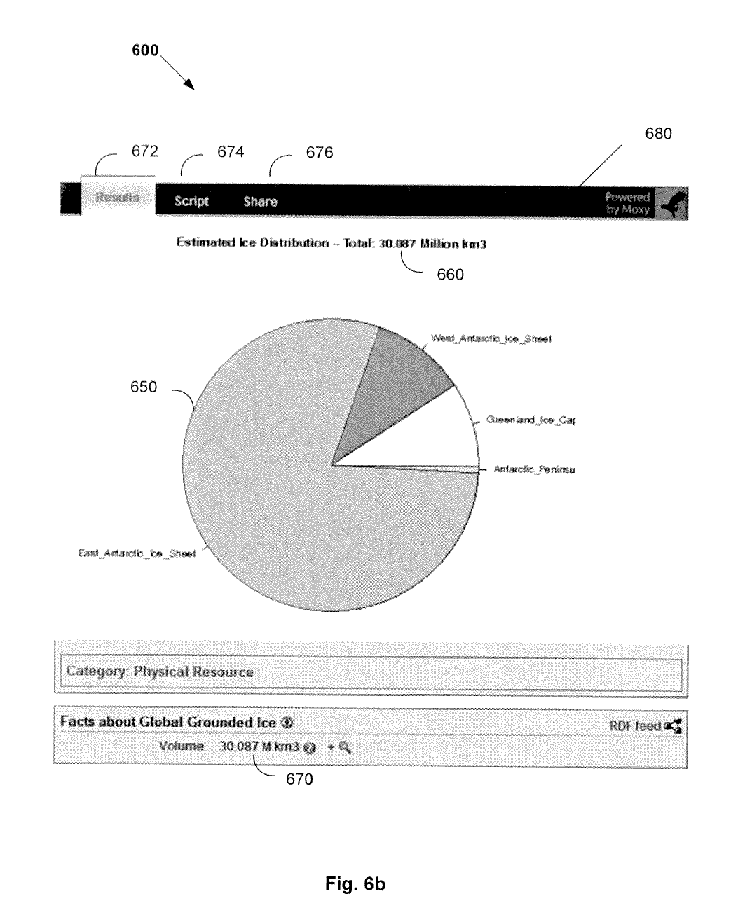

In another example, the data in the “West Antarctic Ice Sheet” page 300 in FIG. 3 can also be used to define the dynamic data on another page 600 entitled “Global Grounded Ice” in FIG. 6. This page 600 describes four grounded ice sheets at various locations, including the “West Antarctic Ice Sheet” in FIG. 3 and three other ice sheets: “Antarctic Peninsula Ice Cap”, the “Greenland Ice Cap” and the “East Antarctic Ice Sheet”. For the purpose of this example, assume that a page similar to FIG. 3 has been created and semantically annotated for these ice sheets using steps 210 to 230 in FIG. 2.

The “Global Grounded Ice” page 600 is defined with the following dynamic data:
(a) a total volume 610 of the four ice sheets;
(b) a summary table 620 having entries that each set out a web link 630 to a respective ice sheet page and its individual volume 635;
(c) a map 640 indicating the GeoLocation of each ice sheet; and
(d) a pie chart 650 of the estimated ice distribution and total volume 660 of the ice sheets.

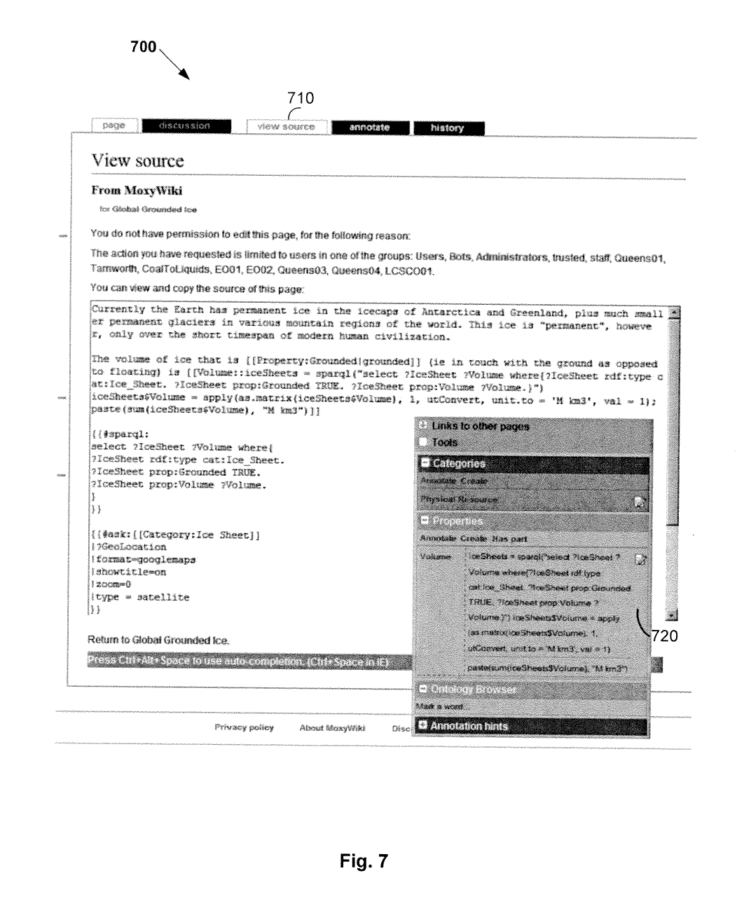

To define the dynamic data, the user 140 can write the following scripts via the “view source” interface 710 in FIG. 7. Alternatively or additionally, the processing unit 114 may automatically generate the scripts based on option selected by the user 140. For example, the user 140 may be provided with a list of possible mathematical operations (such as sum, mean, variance, standard deviation) and output options (text, graphical, audio) for selection. This automatic implementation makes the system more user-friendly for those with little or no knowledge of semantic web language and programming language.

### Example 2(a)

### Total Volume 610

7 [[Volume::iceSheets = sparql(“select ?IceSheet ?Volume
8 where{?IceSheet rdf:type cat:Ice_Sheet. ?IceSheet
9 prop:Grounded TRUE. ?IceSheet prop:Volume ?Volume.}”)
10 iceSheets$Volume = apply(as.matrix(iceSheets$Volume), 1,
11 utConvert, unit.to = ‘M km3’, val = 1);
12 paste(sum(iceSheets$Volume), “M km3”)]]

The above script is defined to calculate the total volume 610 using the respective volume of the four ice sheets listed on the page 600. Lines 1 to 3 model the question “What is the volume of each ice sheet?” using a SPARQL call to retrieve the Volume property of ice sheets that have a “True” value for the Grounded property. Lines 4 and 5 are R codes that convert the unit of the total volume to million km³. Line 6 is R code that evaluates the sum of the volume and displays the result of the evaluation together with its unit “M km³”. The script is saved as the object of the Volume property 670 of the page 600; see FIG. 6 and sub-interface 720 in FIG. 7.

### Example 2(b)

### Summary Table 620

13 {{#sparql:
14 select ?IceSheet ?Volume where{
15 ?IceSheet rdf:type cat:Ice_Sheet.
16 ?IceSheet prop:Grounded TRUE.
17 ?IceSheet prop:Volume ?Volume.
18 }}}

The summary table 620 is defined using the above script. The result of the SPARQL select query in line 8 is a sequence of results that form a table or result set. Each row in the table corresponds to one query solution and each column corresponds to a variable declared in the select clause.

### Example 2(c)

### Map

19 {{#ask:[[Category:Ice Sheet]]
20 |?GeoLocation
21 |format=googlemaps
22 |showtitle=on
23 |zoom=0
24 |type = satellite

The Google map 640 is defined using the above script. The ask query in line 13 tests whether or not there are any pages in the “Ice Sheet” category and returns a Boolean result. If there are such pages, their GeoLocation property will be retrieved.

### Example 2(d)

### Pie Chart

1 {{#ajaxR:
2 iceSheets = sparql(“select ?IceSheet ?Volume
3 where{?IceSheet rdf:type cat:Ice_Sheet. ?IceSheet
4 prop:Grounded TRUE. ?IceSheet prop:Volume?Volume.}”)
5 iceSheets$Volume = apply(as.matrix(iceSheets$Volume),
6 1, utConvert, unit.to = ‘M km3’, val = 1)
7 pie(iceSheets$Volume, main = paste(“Estimated Ice
8 Distribution − Total:”, sum(iceSheets$Volume),
9 “Million km3”), labels=iceSheets$IceSheet)
10 |format=png|width=500|height=500|imagecount=1}}

The graphical representation of the result of the query in Example 2(a) is defined using the above script. Line 1 instructs the processing unit 114 to include a panel 680 and display the result of the query and mathematical operation. Lines 2 to 4 define a SPARQL call that queries against the ontology 124, and saves the result as variable iceSheets. Lines 6 and 7 are R codes that convert all volumes to the same unit of millions of km³. Lines 9 to 11 are R code to draw a pie chart using the pie( ) function and of the sum( ) of the volumes. Line 13 sets the size and type of the pie chart 650.

It will be appreciated that other forms of graphical representations include: box plot, histogram plot, scatter plot, bubble plot, doughnut plot, area plot, line plot, bar plot, column plot and three-dimensional plot.

### Evaluation

When the page 600 with dynamic data in FIG. 6 is accessed by a user 140, the processing unit 114 performs the query and mathematical operations defined in step 240, and presents the page with a result of the query and/or a result of the mathematical operation in graphical form; see steps 250 and 260.

An Aggregator 116 within the processing unit 114 converts definition of the dynamic data (scripts in the previous section) into a format that can be evaluated by a mathematical engine operated by the processing unit 114. The mathematical engine 118 can be implemented in any programming language suitable for statistical computing and graphics, for instance R as used in the examples above.

The Aggregator 116 first identifies all SPARQL queries in scripts 2(a) to 2(d). For each SPARQL query, the Aggregator 116 executes the query against the ontology 124 to obtain the result as an XML result set. The XML result set is then parsed and turned into an R script such that it can be processed by the mathematical engine 118. These steps are repeated in a recursive fashion until no further SPARQL queries are found.

The resulting R script for Example 2(d) is as follows, where the SPARQL call is replaced by a data.frame( ) in line 1 to produce a list of properties and values. Lines 7 to 11 remain unchanged compared with Script 2.

### Example 3

### Converted Script

1 iceSheets = data.frame(IceSheet = c(’Greenland_Ice_Cap’,
2 ‘West_Antarctic_Ice_Sheet’,
3 ‘East_Antarctic_Ice_Sheet’,
4 ‘Antarctic_Peninsula_Ice_Cap’),
5 Volume = c(‘2810000 km3’, ‘3130000 km3’,
6 ‘23920000 km3’, ‘227000 km3’),
7 stringsAsFactors = FALSE)
8 iceSheets$Volume = apply(as.matrix(iceSheets$Volume), 1,
9 utConvert, unit.to = ‘M km3’, val = 1)
10 pie(iceSheets$Volume, main = paste(“Estimated Ice
11 Distribution − Total:”, sum(iceSheets$Volume),
12 “Million km3”), labels=iceSheets$IceSheet)

The result is presented under the “Results” tab 672 in FIG. 6, where both the total volume of grounded ice 660 and a pie chart 650 generated by lines 10 to 12 are presented. Also shown in FIG. 6, the Script tab 674 allows users 140 to view the Converted Script above. The Share tab 676 allows users 140 to embed a link to the result 660 and pie chart 650 into another web page.

The processing unit 114 also sets the Volume property 670 of the page 600 in FIG. 6 to the sum of all globally grounded ice. This property is dynamically calculated when the page is viewed. Advantageously, even when the calculation is updated or another ice sheet is added to the list, the Volume property (iceSheets$Volume) will be automatically recalculated. This approach can be contrasted with static information in the form of text and images on traditional wiki pages.

### Collaborative Modelling

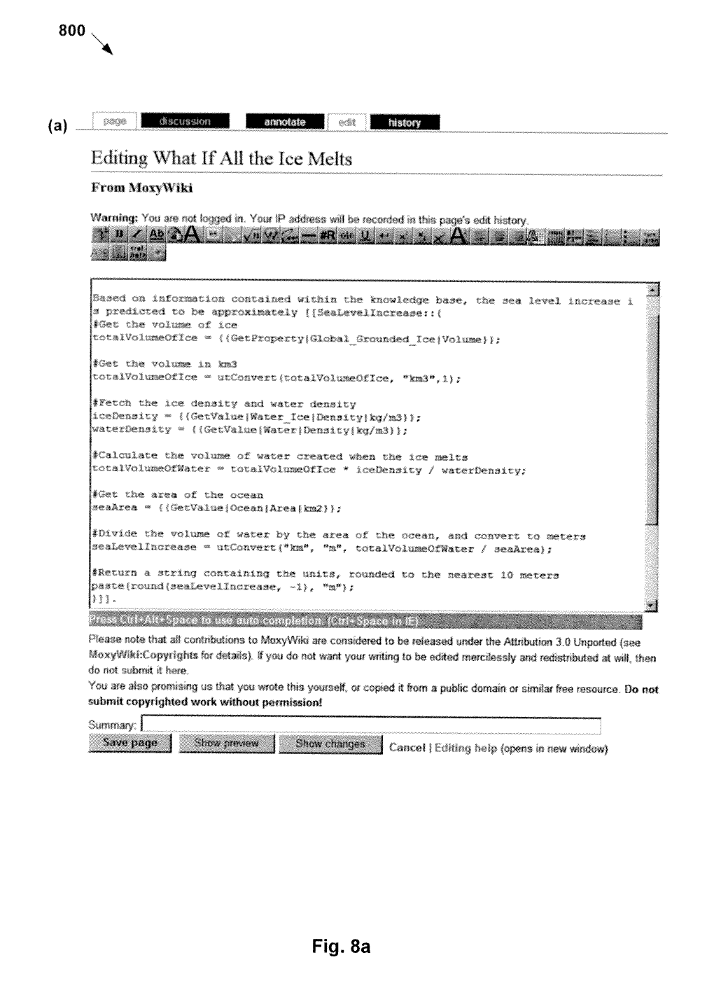

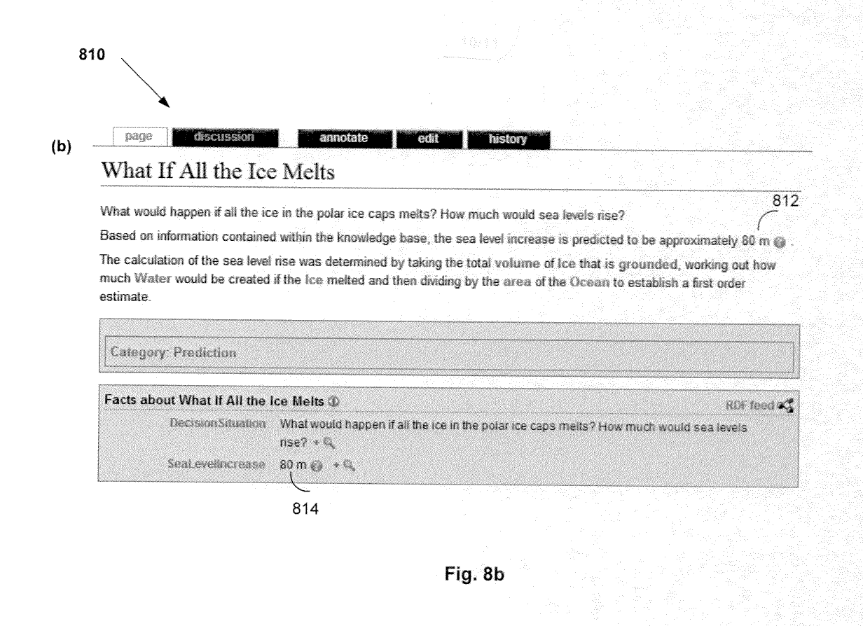

The ontology 124 can also be used by other users 140 to analyse other problems. Referring now to the example in FIG. 8, the volume of global grounded ice can be used to explore how much the sea level would rise if all the ice on the planet melted. FIG. 8(a) shows the MediaWiki script to perform the calculation of sea level rise using the following Script:

### Example 4

### Sea Level Increase

1 [[SeaLevelIncrease::{
2 #Get the volume of ice
3 totalVolumeOfIce={{GetProperty|Global_Grounded_Ice|Volume}};
4
5 #Get the volume in km3
6 totalVolumeOfIce = utConvert(totalVolumeOfIce, “km3”,1);
7
8 #Fetch the ice density and water density
9 iceDensity = {{GetValue|Water_Ice|Density|kg/m3}};
10 waterDensity = {{GetValue|Water|Density|kg/m3}};
11
12 #Calculate the volume of water created when the ice melts
13 totalVolumeOfWater=totalVolumeOfIce*iceDensity/waterDensity;
14
15 #Get the area of the ocean
16 seaArea = {{GetValue|Ocean|Area|km2}};
17
18 #Divide the volume of water by the area of the ocean, and
19 #convert to meters
20 seaLevelIncrease = utConvert(“km”, “m”, totalVolumeOfWater /
21 seaArea);
22
23 #Return a string containing the units, rounded to the
24 nearest 10 meters
25 paste(round(seaLevelIncrease, −1), “m”);}]].

The result of the dynamic calculation is shown on the page 810 in FIG. 8(b), where the output is set out as “approximately 80 m” (see label 812). Similarly, the result is also used to annotate the “What If All the Ice Melts” page 810 semantically by setting the SeaLevelIncrease property defined in line 1 to 80 m (see label 914).

Advantageously, the computer system 100 provides a shared platform for a community of users 140 such as researchers and analysts to build complicated ontology models in a decentralised or peer to peer fashion and to share analysis over the Internet. Using the system 100, central coordination of modelling exercise is not required and ontology models can be created and updated over time. Users 140 can review the quality of recommendations made by other users 140, discover how assumptions influence the output and find existing analysis that can be reused. In such a way, a network of complicated analysis can be created by reusing information captured, or calculated by others.

Using the system 100, users 140 can also capture data relevant to any problem, establish the credibility of the data sources and handle uncertainty associated with data. The system 110 also supports evidence-based decisions where users can build alternative models using the same data, analyse the alternative models and recommend the best course of action for a particular scenario. Users 140 can embed any findings on any web page and build consensus by incorporating improvements based on online discussions with other users 140.

### Ontology Browser 900

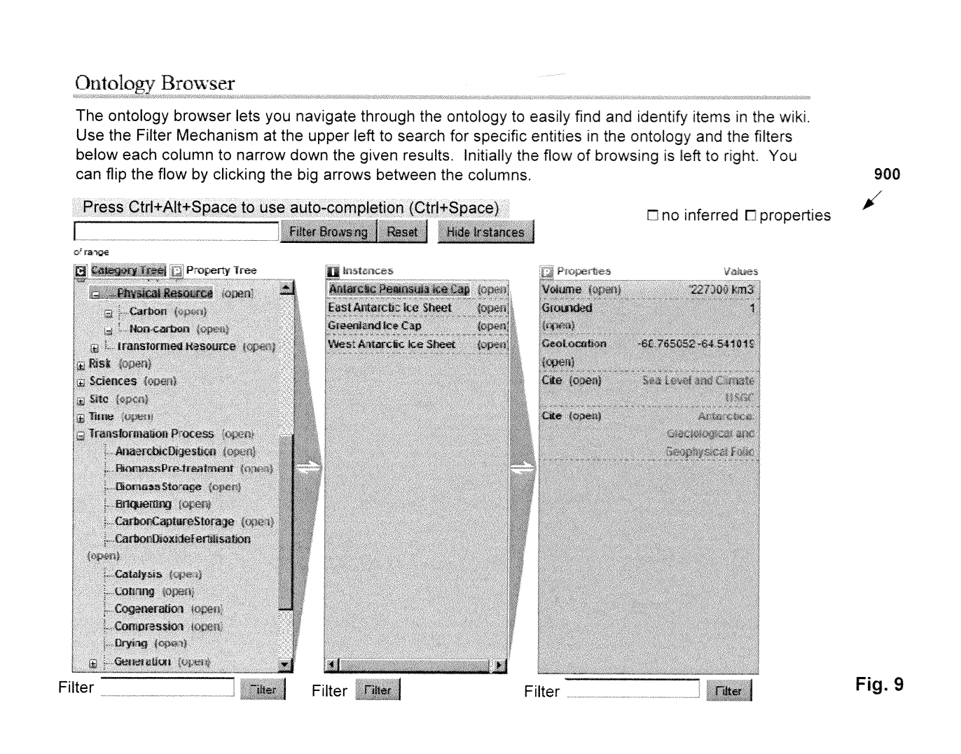

Referring now to FIG. 9, the processing unit 114 also provides an interface for users 140 to navigate through the ontology 124 in the data store 120 to easily find and identify categories and properties of a page.

The ontology 124 represents a living database of system terminology. Users 140 can reuse ontology defined by other users, or add new ones. The interface presents a list of categories in a tree format. When a category is selected, instances of the selected category and their properties can be viewed. For example, there are four instances defined for the “Physical Resource” category. The instance of “Antarctic Peninsula Ice Cap” is further associated with the properties of Volume, Grounded, GeoLocation and Cite.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

For example, MediaWiki, SWIVT, OWL, RDF and R are merely exemplary methods to implement the system 100. Instead of Semantic Wiki, Protoge may be used to construct domain models and knowledge-based applications with ontologies. A description of the Protoge platform is available at http://protege.stanford.edu/ (accessed March 2011), the content of which is incorporated by reference. Any other suitable software or specification may be used.

It should also be understood that, unless specifically stated otherwise as apparent from the following discussion, it is appreciated that throughout the description, discussions utilizing terms such as “receiving”, “processing”, “retrieving”, “selecting”, “calculating”, “determining”, “displaying”, “performing”, “providing” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices. Unless the context clearly requires otherwise, words using singular or plural number also include the plural or singular number respectively.

It should also be understood that the techniques described might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media (e.g. copper wire, coaxial cable, fibre optic media). Exemplary carrier waves may take the form of electrical, electromagnetic or optical signals conveying digital data streams along a local network or a publically accessible network such as the Internet.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

1. A computer-implemented method for collaborative knowledge management, the method comprises the steps of:
(a) providing an interface for users to create or edit pages of a collaborative knowledge base, to add semantic annotations to the pages, and to define dynamic data on the pages;
wherein ontological statements are created for the semantic annotations to form part of an ontology; and the dynamic data is defined using a query against the ontology and a mathematical operation on a result of the query; and
(b) when a page with dynamic data is accessed, dynamically performing the query and the mathematical operation, and presenting the page with a result of the query or a result of the mathematical operation, or both, in graphical form.

2. The method according to claim 1, wherein performing the mathematical operation further comprises converting the query, or the result of the query, into a form that can be evaluated by a mathematical engine.

3. The method according to claim 2, wherein the mathematical engine is implemented using any one of the following programming languages: R, Matlab, Octave, PHP and Python.

4. The method according to claim 1, further comprising semantically annotating the page accessed with the result of the mathematical operation.

5. The method according to claim 1, wherein the ontological statements Resource Data Framework (RDF) statements each comprising a triple of (subject, predicate, object).

6. The method of claim 5, wherein the query is a SPARQL query against the ontology.

7. The method according to claim 1, wherein semantic annotations include one or more categories and properties.

8. The method according to claim 8, further comprising providing an interface for the users to select the one or more categories and properties during semantic annotation.

9. The method according to claim 1, further comprising providing an interface for the users to select the mathematical operation, and automatically generating a script to perform the selected mathematical operation.

10. The method according to claim 1, further comprising providing an interface for the users to select the graphical form.

11. The method according to claim 1, wherein the graphical form is a plot generated using the result of the query or the result of the mathematical operation, or both,

12. The method according to claim 1, wherein the graphical form is a map indicating the result of the query or the result of the mathematical operation, or both.

13. The method according to claim 1, wherein the knowledge base is implemented using Semantic Wiki.

14. A computer-readable medium having computer-executable instructions for implementating the method for collaborative knowledge management according to claim 1.

15. A computer system for collaborative knowledge management, the computer system comprising:
a data store to store a knowledge base comprising pages created and editable by multiple users and an ontology comprising ontological statements; and
a processing unit operable to:
(a) provide an interface for users to create or edit pages of the collaborative knowledge base, to add semantic annotations to the pages, and to define dynamic data on the pages;
wherein ontological statements for the semantic annotations form part of the ontology in the data store; and the dynamic data is defined using a query against the ontology and a mathematical operation on a result of the query; and
(b) when a page with dynamic data is accessed, dynamically perform the query and the mathematical operation, and present the page with a result of the query or a result of the mathematical operation, or both, in graphical form.
